(19) United States
(12) Patent Application Publication
(10) Pub. No.: US 2008/0243882 A1
(43) Pub. Date: Oct. 2, 2008

(54) UPDATING OF LINK TO DATA REPOSITORY

(75) Inventors: Nicholas R. Bailey, Southampton (GB); Margaret A. Beynon, Coventry (GB); Peter J. Stretton, Hampshire (GB)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/053,444

(22) Filed: Mar. 21, 2008

(30) Foreign Application Priority Data
Mar. 27, 2007 (EP) 07105027.2

(51) Int. Cl. G06F 17/30

(52) U.S. Cl. 707/100; 707/E17.005

(57) ABSTRACT

A method of operating a communication system which comprises a plurality of clients and a data repository, comprises the steps of detecting a location change of the data repository, acquiring data defining the clients connected to the data repository, transmitting a component to each client defined by the data, receiving the component at each client, and updating a user link to the data repository, at each client, according to the component. The step of transmitting a component to each client defined by the data comprises can comprise replicating an agent for each client.

### FIELD OF THE INVENTION

The present invention relates to a method of operating a communication system and to the communication system itself. The invention provides a repository location communication system.

### DESCRIPTION

In distributed data repository systems, which comprise multiple clients and at least one data repository, links are stored at the client systems for access to remote data repositories. These links allow a user to access, through their client device or interface, the data stored by the repository. A user, through an application such as Lotus Notes will have one or more user links that are provided as buttons on the graphical user interface to the application. Each button will provide a link to a specific repository, and the user accesses the button in the conventional fashion, through the use of the mouse and the on-screen cursor. Once a button is pressed, the link connects to the data repository and the user can then access the required data. In many such systems, the data repository maintains an access control list of those users (or user machines) that have the necessary security clearance to access the repository.

Such a distributed system is dynamic, and it is common for a data repository to be moved. This move can be a physical movement of the data to a new location, or can be a logical movement, for example if a restructuring of the data hierarchy takes place. The physical movement of the data repository may be as a result of the data being stored, by the data repository, reaching a size such that the current physical hardware on which the repository resides no longer sufficiently supports the required access to the data.

When a data repository is moved, either using the link fails back with a “not found” message, and the user is stuck unless he or she contacts the repository owner, or happens to be able to use the underlying “raw” interface to locate the repository and re-establish the link; or it is necessary for the repository administrator manually to distribute a new link to all those on the access control list. Neither of these current working arrangements is ideal, as the first is unsatisfactory for the users, and the second introduces the possibility of human error into the process and also creates a requirement for an administrator task, which could be disruptive to the current workload of the relevant personal.

It is therefore an object of the invention to improve upon the known art.

According to a first aspect of the present invention, there is provided a method of operating a communication system, the system comprising a plurality of clients and a data repository, the method comprising the steps of detecting a location change of the data repository, acquiring data defining the clients connected to the data repository, transmitting a component to each client defined by the data, receiving the component at each client, and updating a user link to the data repository, at each client, according to the component.

According to a second aspect of the present invention, there is provided a communication system comprising a plurality of clients, a data repository and an agent, the agent arranged to detect a location change of the data repository, to acquire data defining the clients connected to the data repository, and to transmit a component to each client defined by the data, and each client arranged to receive the component at each client, and to update a user link to the data repository, at each client, according to the component.

According to a third aspect of the present invention, there is provided a computer program product on a computer readable medium for operating a communication system, the system comprising a plurality of clients and a data repository, the product comprising instructions for detecting a location change of the data repository, for acquiring data defining the clients connected to the data repository, for transmitting a component to each client defined by the data, for receiving the component at each client, and for updating a user link to the data repository, at each client, according to the component.

Owing to the invention, it is possible to provide a system that can automatically update the users who are linked to a data repository. In one embodiment, the invention makes use of a very small server-side intelligent agent mechanism (preferably an aglet) that is capable of having awareness, achieved by an interrogation mechanism, of the repository's location. When the repository moves to a new server, the aglet spawns clones of itself and transmits them to all the repository's registered clients. The aglet could, for example, query and retrieve the userids of all those on the access control list, or on a user log and transmit its clones to them.

On arrival at each client, the aglet would instruct the repository client program to update the client side links to the moved repository. Advantageously, aglets can be added on to existing repository systems (such as large, distributed CASE repository systems or distributed databases) without the need to modify the repository system itself. Further advantageously, because aglets operate in a sandboxed manner, customers can be reassured that the addition of such aglets will not interfere with their stored data or with the auditability characteristics of their repository systems. Equally advantageously, aglets are very small, thus keeping down the costs of transmitting and storing them to an acceptable level, even in very complex systems.

One possibility is that at repository set-up time, a server-side aglet is associated with each repository. The aglet's detector component queries the system and records the location information. By means such as periodical querying, the aglet later detects that its repository has been moved. Once this is detected, the aglet's client information retrieval component then retrieves the addresses of all clients on the access control list for the repository and transmits a component (which may be a replica of the aglet) to each client connected to the data repository.

Embodiments of the present invention will now be described, by way of example only, with reference to the accompanying drawings, in which:

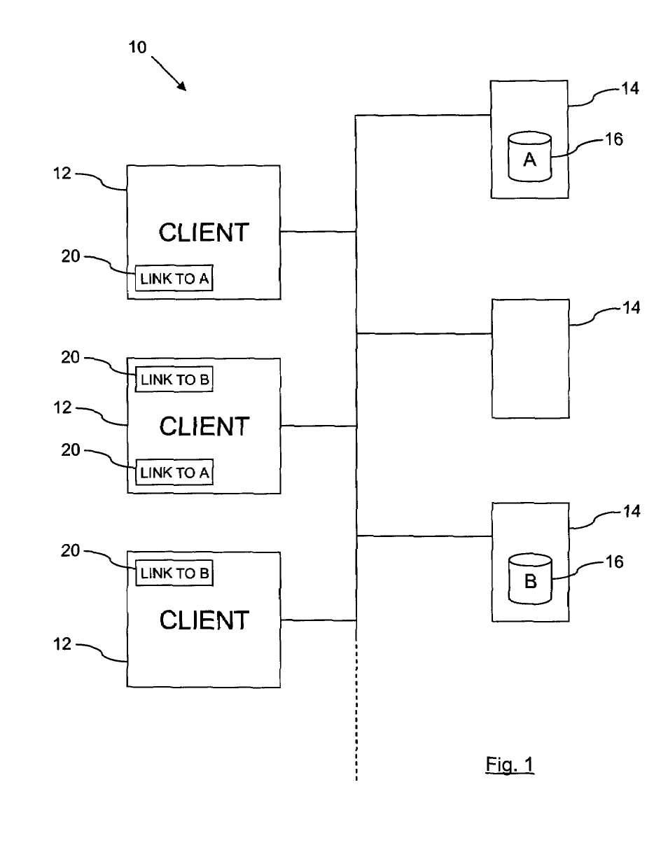

FIG. 1 is a schematic diagram of a communication system,

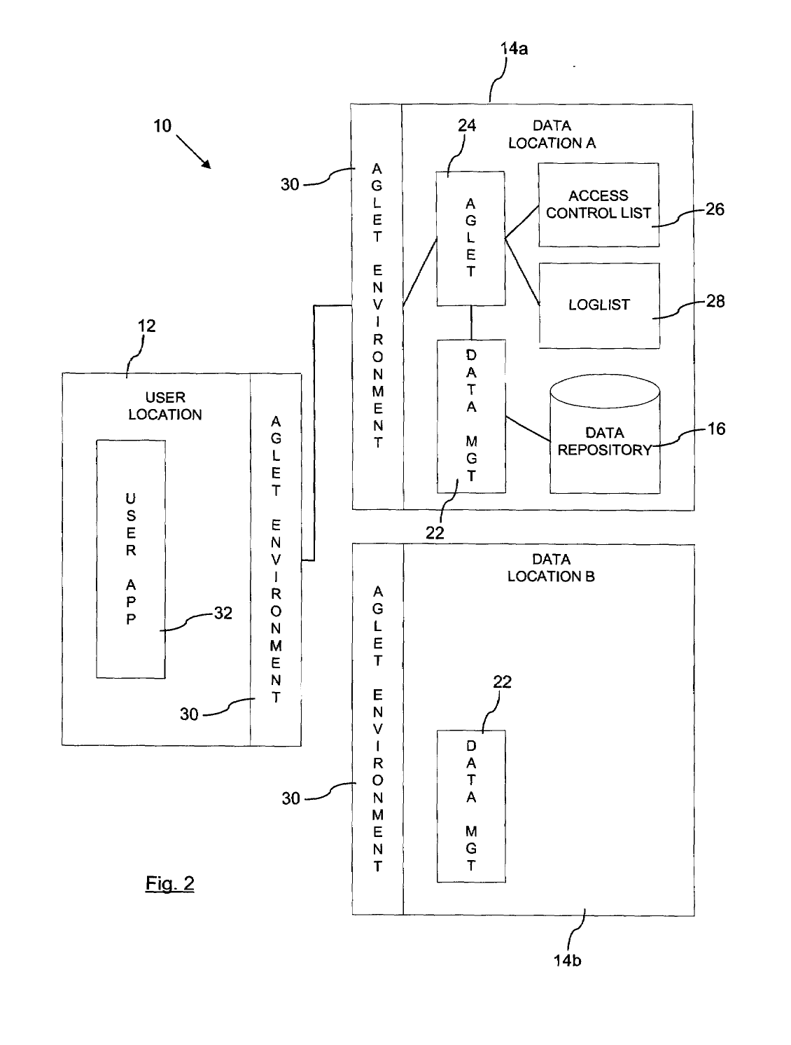

FIG. 2 is a more detailed schematic diagram of part of the communication system of FIG. 1,

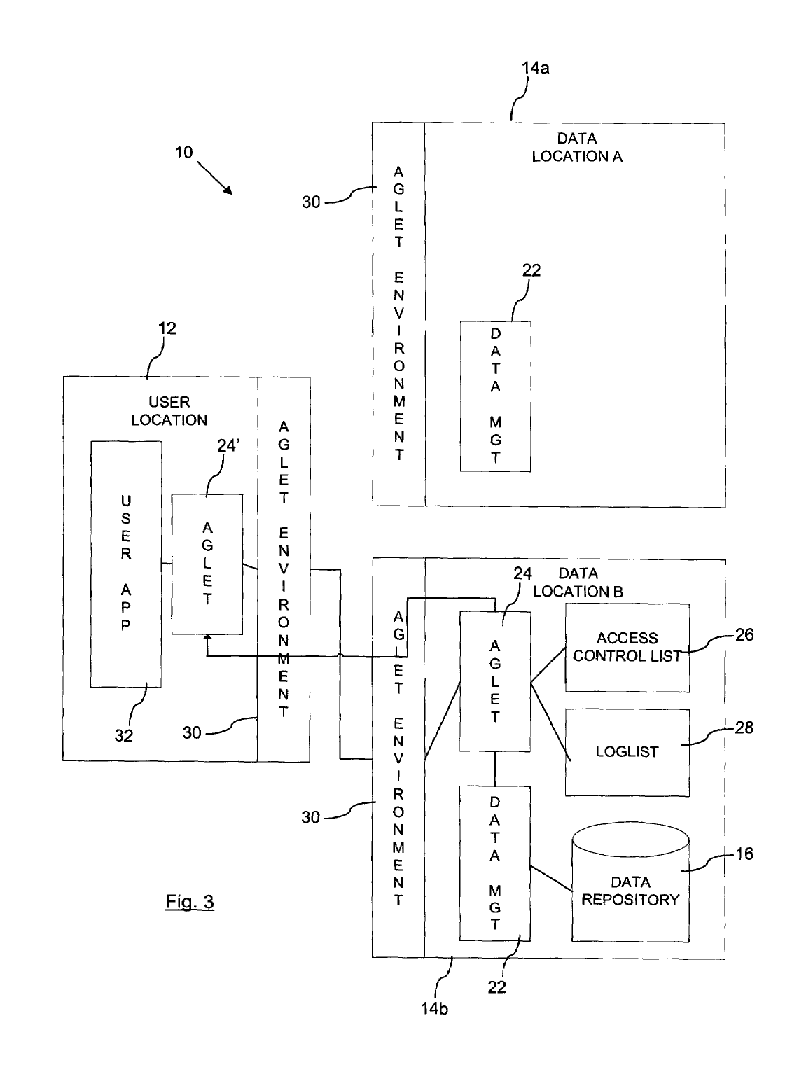

FIG. 3 is a diagram, similar to FIG. 2, of the communication system, following movement of a data repository,

An example of a communication system 10 is shown in FIG. 1. The communication system 10 comprises a plurality of clients 12, data locations 14 and data repositories 16. A network 18 interconnects the clients 12 and the data locations 14. Each data repository 16 is positioned at a specific data location 14. In a practical embodiment of the system 10, the clients 12 could be standard desktop computers that are connected to an Ethernet network 18 which connects the client devices 12 to servers 14 (or RAID arrays 14). These servers 14 each have the capability to maintain one or more databases 16. Each data repository 16 is physically and logically located at a specific data location 14. A data repository 16 may be a piece of hardware such as a specific disk within a RAID array, or may be a software application or file that stores data.

The clients 12 each access a respective data repository 16 via a data link 20, which connects the client to the current location of the specific data repository 16. Each client 12 can have multiple data links 20, each of which will connect to a different data repository 16. In the context of the client 12 being a desktop PC, then an application such as Lotus Notes will provide the user of the PC 12 with a method of accessing the links 20. For example, Lotus Notes provides a graphical interface that provides on-screen one or more “buttons” that can be “pressed” by a user via their on-screen cursor. A possible function of one such button could be to connect the user via the data link 20 to the desired data repository 16. The user is usually unaware of the link 20 behind the button, this is stored by the client 12, and the button simply names the data repository 16 to which the user is trying to connect.

FIG. 2 shows a more detailed illustration of a single client 12 and two data locations 14a and 14b. A single data repository 16 resides at the location 14a, and a data management unit 22 performs read and write instructions on the data stored by the data repository 16. An intelligent agent 24 is also present at the data location 14, and in the preferred embodiment of the invention, each data repository 16 has an associated agent 24. The agent 24 “lives” with the associated data repository 16, and moves with that data repository 16. One method of embodying the agent 24 is to use aglet technology. This is a JAVA based technology. An aglet is an agent which can autonomously and spontaneously move from one device to another carrying executable code.

The agent 24 is connected to an access control list 26 and a user log 28. The access control list 26 contains the details of those clients 12 that are allowed to access the data repository 16 (or in some cases the extent of their access to the data repository 16). The user log 28 contains the details of the actual connections that are made to the data repository 16, thereby keeping track of the clients 12, as and when they access the data repository 16. Not all data locations will necessarily be provided with either or both of the access control list 26 and a user log 28. Also present at the data location 14 is an executing environment 30, such as JAVA virtual machine, which allows the agent 24 to function, within the correct security environment.

The client 12 runs a user application 32, such as Lotus Notes, which supports the user's access to the data repository 16. The client 12 also has present an executing environment 30, so that interaction with the agent 24 is possible. Similarly, the second data location 14b is provided with executing environment 30, and a data management unit 22. FIG. 2 shows the communication system 10 as it is operated prior to any change in the location of the data repository 16. This is the configuration that supports the change in the location of the data repository 16, without the problems associated with the prior art system.

If a change in the location of a data repository 16 is needed, then the communication system 10 is designed to respond to this change in a specific manner. The change may come about because the data repository 16 has grown to such a size that the current location of the data repository 16 no longer adequately supports the amount of data stored. Equally, another reason for the movement of the data repository 16 may be that the number of data requests that clients 12 are making to the data repository 16 is too large for the hardware that are supporting the specific location 14, where the data repository 16 resides, to handle.

Once a data repository 16 is moved then the communication system 10 configuration as shown in FIG. 3 will occur. In this example, the data repository 16 has been moved by an administrator from data location 14a to data location 14b. When this takes place, all of the data links 20 currently stored by the individual clients 12, which are connecting a client 12 to the data repository 16, will no longer function.

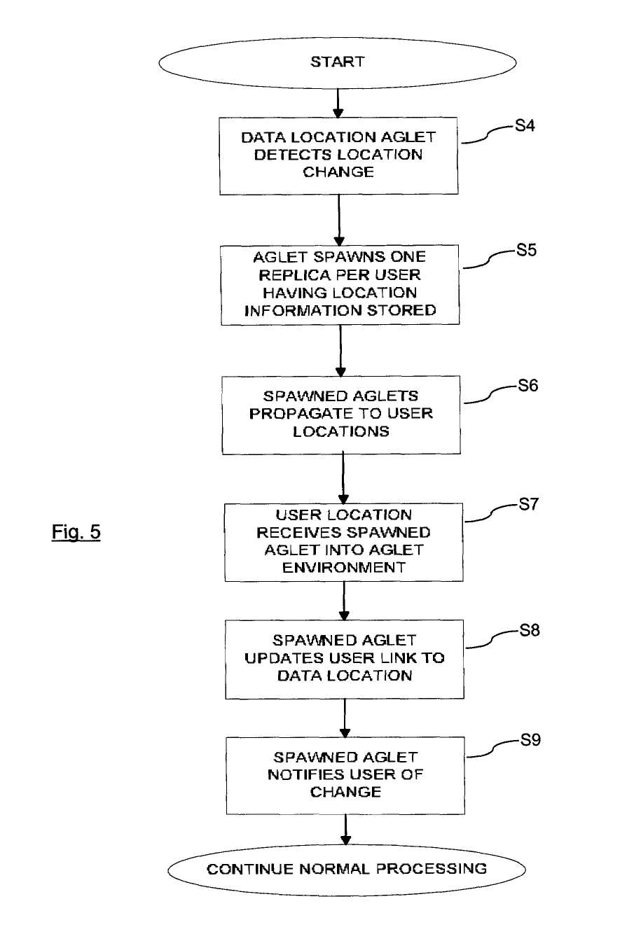

However, the agent 24 (in this embodiment an aglet) is monitoring the location of the data repository 16. When the agent 24 notices the location change in the data repository 16, then this change triggers a process controlled by the internal structure of the agent 24. The result of the process is that each client 12 that stores a data link 20 for that data repository 16 will be updated automatically, and in the background, by the agent 24. This methodology is described in detail below, with reference to FIG. 5, but the principal of system 10 is that a replica aglet 24′ is generated, which travels to each client 12, and performs the updating of the data link 20.

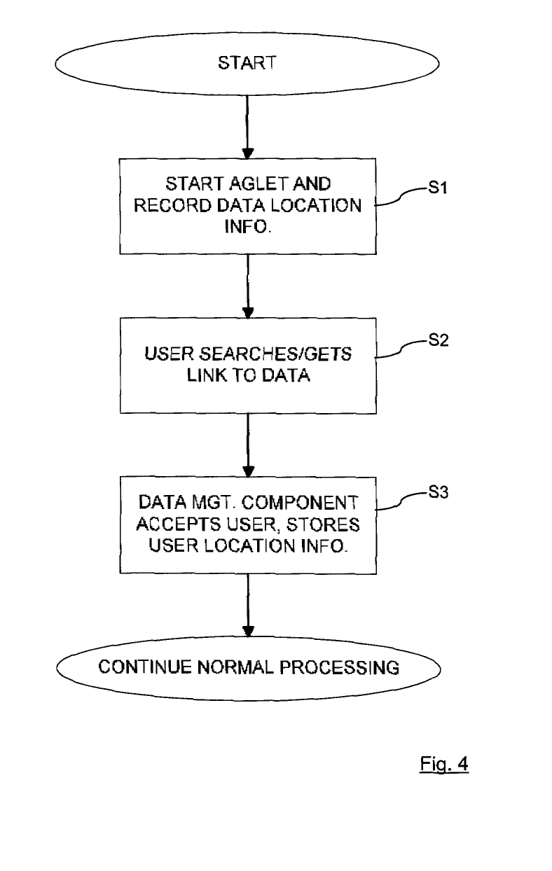

Prior to the detection of any change of location, the communication system 10 needs to initialise. A typical process flow is shown in FIG. 4, of the setup phase of the system 10. Step S1 is the start of the agent/aglet 24, which records the present location information of the data repository 16 (being the user location 14), to which the agent 24 is attached. The second step S2, is for one or more clients 12 to search or to be given the link 20 to the data repository 16.

Each individual client 12 will store the link 20, which allows that client to reach the respective data repository 16. At step S3, at the data location 14, the local data management unit 22 accepts the client connection and records the client location (which may be an email or network address, for example). The client 12 allows database/application aglet/agent privileges through the appropriate security settings. The system 10 will continue to operate, adding new clients to the connection to the data repository 16, as and when additional clients request open access to the data repository 16.

Once a change in the location of the data repository 16 takes place, then the process as shown in FIG. 5 will operate and the process of managing the change in the location of the data repository 16 comes into effect. The first step in the location change management is the step S4, wherein the database aglet 24 detects a location change of the data repository 16. This detection may be achieved by the agent 24 itself, polling continually to check the current location of the data repository 16, or it may be that the data repository 16 communicates to the agent 24 that a changed in location has taken place. Either way, the agent/aglet 24 becomes aware that a change in the location of the data repository 16 has occurred.

The next step S5, is that the agent 24 acquires data defining the clients 12 connected to the data repository 16 and spawns self replicas, one per client, with client information. The database aglet 24 must gather registered user data. This can be obtained from the access control list 26 or the user log 28, or the data management unit 22 may store the necessary data. This user data details those clients 12 that need to be informed about the change in location of the data repository 16. Once the information is obtained, then copies of the agent 24 can be created. If the agent 24 is accessing the user log 28, then a time period such as the last three months may be specified to identify those users who should be notified of the change.

At step S6, the spawned aglets 24 propagate to the clients 12. The agent 24 is transmitting a component to each client 12 defined by the data that was acquired in the previous step. In the preferred embodiment, this component that is transmitted to each of the clients 12 is actually a replica of the agent 24, but other possibilities (such as email messages) could also be used as a way of communicating with the client devices 12.

Once the component is transmitted to the clients 12, then at step S7, each client 12 receives and allows the spawned aglet 24 to run. The executing environment 30 that is maintained by each client 12 has the correct security settings to allow the spawned agent 24 to be accepted and executed on that client 12. At step S8, the spawned aglet 24 executes and updates the client link 20 to the data repository 16. At this step S8 there occurs the updating of the data link 20 to the data repository 16, at each client 12, according to the received component (the copy of the agent 24). Finally, as an option, at step S9, the spawned aglet 24 notifies the client 12 of the change in the location of the data repository and whether a successful or failed update of the data link 20 has taken place. This step is optionally, as the system 10 could be configured so that all of the updating of the data links 20 stored by the clients 12 could occur in the background, without the user of a client being aware that when they connect to a repository 16 it is now in a new location.

The basic mechanism described above is extensible from the simple client 12 and data repository 16 scenario to client, broker and provider architecture. For example (where AS denotes Aglet Service/Server attached to Client, Database, Broker or Provider), FIGS. 2 and 3 can be represented as:
[Client: AS]<---------->[AS:Database]

However, more complex relationships can be covered by the same methodology. For example,
[Client:AS]<------->[AS:Broker:AS]<------->[AS:Provider]

which can be extended to:
[Client:AS]<-------->[AS:Provider_1:AS]<-------->[AS:Provider_2:AS]<----- . . . . . ----->[AS:Provider_n:AS]<------- . . . . . ----->[AS:Provider_n+1:AS]

This extensibility allows for any party in the link chain to be moved without breaking the chain as link information is maintained in both directions, or in multiple directions for ‘star’ linked networks. Components can replicate through a chain of connections to ensure that the ultimate client 12 is made aware of the change in location of the data repository 16 to which the client 12 is connected, under the control of the locally stored user link 20.

1. A method of operating a communication system, the system comprising a plurality of clients and a data repository, the method comprising the steps of
detecting a location change of the data repository,
acquiring data defining the clients connected to the data repository,
transmitting a component to each client defined by the data,
receiving the component at each client, and
updating a user link to the data repository, at each client, according to the component.

2. A method according to claim 1, and further comprising notifying each client of the updating of the user link.

3. A method according to claim 1 wherein the step of acquiring data defining the clients connected to the data repository comprises accessing an access control list.

4. A method according to claim 1 wherein the step of acquiring data defining the clients connected to the data repository comprises accessing a user log.

5. A method according to claim 1 wherein the step of transmitting a component to each client defined by the data comprises replicating an agent for each client.

6. A communication system comprising a plurality of clients, a data repository and an agent, the agent arranged to detect a location change of the data repository, to acquire data defining the clients connected to the data repository, and to transmit a component to each client defined by the data, and each client arranged to receive the component at each client, and to update a user link to the data repository, at each client, according to the component.

7. A system according to claim 6, wherein the agent is further arranged to notify each client of the updating of the user link.

8. A system according to claim 6 wherein the agent is arranged, when acquiring data defining the clients connected to the data repository, to access an access control list.

9. A system according to claim 6 wherein the agent is arranged, when acquiring data defining the clients connected to the data repository, to access a user log.

10. A system according to claim 6 wherein the agent is arranged, when transmitting a component to each client defined by the data, to replicate an agent for each client.

11. A computer program product on a computer readable medium for operating a communication system, the system comprising a plurality of clients and a data repository, the product comprising instructions for detecting a location change of the data repository, for acquiring data defining the clients connected to the data repository, for transmitting a component to each client defined by the data, for receiving the component at each client, and for updating a user link to the data repository, at each client, according to the component.

12. A computer program product according to claim 11, and further comprising instructions for notifying each client of the updating of the user link.

13. A computer program product according to claim 11 wherein the instructions for acquiring data defining the clients connected to the data repository comprises instructions for accessing an access control list.

14. A computer program product according to claim 11 wherein the instructions for acquiring data defining the clients connected to the data repository comprises instructions for accessing a user log.

15. A computer program product according to claim 11 wherein the instructions for transmitting a component to each client defined by the data comprises instructions for replicating an agent for each client.
